(19) United States
(12) Patent Application Publication
(10) Pub. No.: US 2012/0297132 A1
(43) Pub. Date: Nov. 22, 2012

(54) MOTHERBOARD OF COMPUTING DEVICE

(75) Inventors: BO TIAN, Shenzhen City (CN); GUO-YI CHEN, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/211,242

(22) Filed: Aug. 16, 2011

(30) Foreign Application Priority Data
May 18, 2011 (CN) 201110129121.2

(51) Int. Cl. G06F 12/00

(52) U.S. Cl. 711/105; 711/E12.001

(57) ABSTRACT

A motherboard of a computing device includes a dual inline memory module (DIMM), a processor socket, a platform controller hub (PCH), a switch, and a switch controller. The DIMM is connected to the processor socket or the PCH through the switch controller. The switch is connected to the switch controller, and generates a signal when the switch is operated. The switch controller controls the DIMM to connect either to the processor socket or to the PCH according to the signal, so that a solid state disk (SSD) or a memory that is connected to the DIMM can be supported appropriately by the motherboard.

### BACKGROUND

1. Technical Field

Embodiments of the present disclosure relate to a motherboard of a computing device.

2. Description of Related Art

Many computing devices provide large storage capacities and large memory capacities. Some users like the computing devices to have a large storage capacity, others prefer the computer to have a large memory capacity. In general, a plurality of dual inline memory modules (DIMMs) may be installed on a motherboard of a computing device, to satisfy the requirements of users who want large memory capacities. However, most users do not use all of the DIMMs, which may waste some resources of the motherboard. For these reasons, some of the DIMMs are designed to connect as solid state disks (SSDs), to satisfy user requirements who want large storage capacities, and avoid waste. But, if a DIMM is designed to connect as a SSD, it would not be used as a memory, but as a storage device.

### BRIEF DESCRIPTION OF THE DRAWINGS

The FIGURE is a block diagram of one embodiment of a motherboard of a computing device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

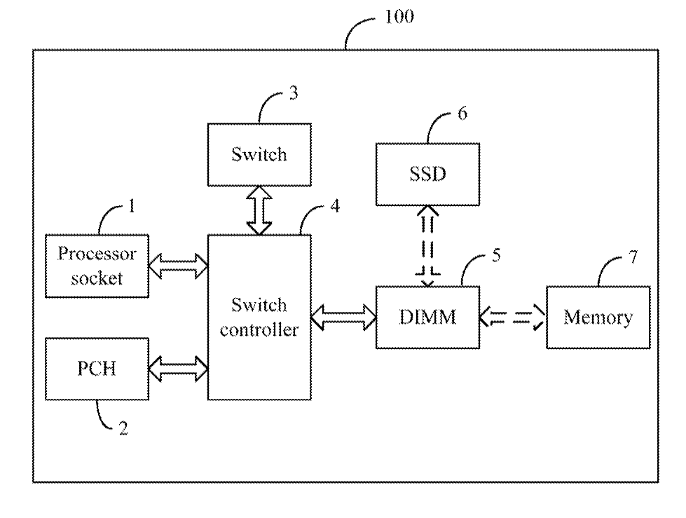

The FIGURE is a block diagram of one embodiment of a motherboard 100 of a computing device. In one embodiment, the computing device may be a computer or a server. The motherboard 100 includes a processor socket 1, a platform controller hub (PCH) 2, a switch 3, a switch controller 4, and a dual inline memory module (DIMM) 5. In addition, a solid state disk (SSD) 6 or a memory 7 may be connected to the DIMM 5 according to requirements of a user. The memory 7 is a random access memory (RAM), such as a double data rate type three synchronous dynamic random access memory (DDR3 SDRAM). In the embodiment, only one DIMM 5 is shown in FIG. 1. In other embodiment, the motherboard 100 may include two or more DIMMs 5 to support a plurality of SSDs 6 or memories 7. FIG. 1 is only one example of the motherboard 100 and it can include more or fewer components than shown in the embodiment, or a different configuration of the various components.

The DIMM 5 is connected to either the processor socket 1 or to the PCH 2 through the switch controller 4. The PCH 2 manages and controls peripheral components, such as storage devices and input/output (IO) devices of the computing device. When the DIMM 5 is connected to the processor socket 1, the motherboard 100 can support the memory 7, so the memory 7 can be connected to the DIMM 5 and work under the control of a processor in the processor socket 1. In the embodiment, the processor includes a memory controller hub (MCH) to control the memory 7 that is connected to the DIMM 5. When the DIMM 5 is connected to the PCH 2, the motherboard can support the SSD 6, so the SSD 6 can be connected to the DIMM 5 and work under the control of the PCH 2.

The switch 3 is connected to the switch controller 4, and generates a signal when the switch 3 is operated. In one embodiment, the signal may be a first switch signal or a second switch signal. The first switch signal may be a high level signal, such as logic 1, the second switch signal may be a low level signal, such as logic 0. The switch 3 may be a toggle switch operable with an up and down movement, or a forwards and backwards movement. In one example, the first switch signal is generated when the switch 3 is moved up or forwards, and the second switch signal is generated when the switch 3 is moved down or moved backwards.

The switch controller 4 controls the DIMM 5 to connect to the processor socket 1 according to the first switch signal, so that the motherboard 100 can support the SSD 6 that is connected to the DIMM 5. The switch controller 4 further controls the DIMM 5 to connect to the PCH 2 according to the second switch signal, so that the motherboard 100 can support the memory 7 that is connected to the DIMM 5. The switch controller 4 may be, for example, a multiplexer, or an analog switch chip.

In one example, the switch 3 is operated to generate the first switch signal when the SSD 6 is connected to the DIMM 5. Then, the switch controller 4 controls the DIMM 5 to connect to the PCH 2 according to the first switch signal, so the SSD 7 may be controlled by the PCH 2 and receive support from the motherboard 100. The switch 3 may also be operated to generate a second switch signal when the memory 7 is connected to the DIMM 5. Then, the switch controller 4 may connect the DIMM 5 to the processor socket 1 according to the second switch signal, so the memory 7 can be controlled by the processor in the processor socket 1 with support from the motherboard 100.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A motherboard of a computing device, comprising:
a dual inline memory module (DIMM), a processor socket, a platform controller hub (PCH), a switch, and a switch controller;
the switch being connected to the switch controller, and configured for generating a signal when the switch is operated, wherein the signal is a first switch signal or a second switch signal; and
the DIMM being controlled to connect to the processor socket by the switch controller according to the first switch signal, or being controlled to connect to the PCH by the switch controller according to the second switch signal.

2. The motherboard according to claim 1, wherein the switch is a toggle switch operable with a up and down movement, or a forwards and backwards movement.

3. The motherboard according to claim 2, wherein the first switch signal is generated when the switch is moved up or forwards.

4. The motherboard according to claim 2, wherein the second switch signal is generated when the switch is moved down or moved backwards.

5. The motherboard according to claim 1, wherein the DIMM connects to a solid state disk (SSD) controlled by the PCH when the PCH is connected to the DIMM.

6. The motherboard according to claim 1, wherein the DIMM connects to a memory controlled by a processor in the processor socket when the processor socket is connected to the DIMM.

7. The motherboard according to claim 6, wherein the processor comprises a memory controller hub (MCH).
